(19) United States
(12) Patent Application Publication
(10) Pub. No.: US 2020/0312045 A1
(43) Pub. Date: Oct. 1, 2020

(54) mobile electronic bidirectional counting apparatus

(71) Applicant: David Anthony Justice, Dallas, GA (US)

(72) Inventor: David Anthony Justice, Dallas, GA (US)

(21) Appl. No.: 16/364,576

(22) Filed: Mar. 26, 2019

(51) Int. Cl. G07C 1/12; G06F 15/02; G06F 3/0482; G06F 3/0484; G06F 3/0488; G09G 5/14; G09G 5/02; G06F 3/16

(52) U.S. Cl. CPC G07C 1/12; G06F 15/025; G06F 3/0482; G06F 3/04847; G06F 3/04886; G09G 2380/10; G09G 5/02; G06F 3/167; G06F 2203/04803; G09G 2320/0666; G09G 2354/00; G09G 5/14

(57) ABSTRACT

Disclosed is a mobile electronic bidirectional counting apparatus (MEBCA), etc., that accurately counts the number of occupants that board and debark any large passenger transport vehicle (LPTV) (i.e. bus or van). This mobile electronic bidirectional counting apparatus is specifically designed to ensure that every passenger that enters a LPTV serving the public is never left on a LPTV after the end of vehicle operation. The mobile electronic bidirectional counting apparatus is comprised of: two application running units, two function execution units and a memory-storing unit. The application unit runs the applications program within the execution phase of operation; in conjunction, the function unit generates a specific task output upon the completion of the first function execution unit; displaying a numerical character with sound corresponding to the displayed numeric character. The memory-storing unit stores the number of passengers that enter the LPTV.

### FIELD

The present invention relates to a mobile electronic bidirectional counting apparatus, and more particularly, a mobile electronic bidirectional counting apparatus that records the number of passengers that board and debark LPTVs i.e. buses or vans.

### BACKGROUND

Recently, children have been unintentionally left on school buses upon the completion of established bus routes. Equally, children have been left at field trips sites only to be discovered missing upon return to trip origin. Due to over whelming concern for the safety of children, procedures have been implemented to rectify these unfortunate occurrences. However, current procedures have not been very effective and children continue to be left behind, scared and unaware of where they are with no one to comfort or protect them. Therefore, the mobile electronic bidirectional counting apparatus has been designed to accurately count the number of passengers that board and debark any LPTV or thereof. The apparatus ensures that every passenger that boards a LPTV debarks the same said vehicle, and never left on any LPTV at the end of said vehicle operation. Additionally, the apparatus does not require passengers to maintain a key card to engage the apparatus but simple a human hand. To overcome the above-described inefficiency in children safety, the objective of this disclosure is to aid operators (bus drivers) in accurately counting children that board and debark LPTVs (buses or vans). Further, the application can be used on a touch screen apparatus that can display a numerical character with sound thereof. The interactive display will also help improve children's learning, cognitive and motor skills.

### RELATED ART

Each running program must have the capability to effectively run on an operating system (OS) with the capacity to provide multiple operations of execution; additionally, it is required that the program be fully equipped to function by design in a separate execution environment intended for the designated operation; with the ability to toggle as needed from one environment of execution to another.

As described above, the operator can switch from one desired execution environment to another according to the needed function; thus, the first execution environment dependent operational capacity is changed once the second execution environment dependent operational capacity is activated.

Similarly, wherein a program operates on an operating system with the capability of running multiple execution environments, with the ability to provide the same function in the execution environments; exclusively designed for each execution environment. Further, the user interfaces differ from one another, just as the function within the execution environment differ from one another.

### SUMMARY

According to the different facets of the invention, there are different application units, and different function execution units. The mobile electronic bidirectional counting apparatus containing; a first application running unit, a first function execution unit, a second application-running unit, and a second function execution unit. It is further determined that the first application running unit performs within an execution environment thereby running an application program. Equally, within the execution environment the first function execution unit operates; wherein it provides a specific function; subsequently the first function execution unit is activated by the running unit of the first application. Within a different execution environment, the second application running unit functions entirely separate from the first application program. Additionally, within a different environment of execution, the second function execution unit performs; after the first function execution unit, the second function execution unit is activated by the second application running unit acquiring a said result.

### BRIEF DESCRIPTION OF THE DRAWINGS

An exemplary embodiment of the present invention will be described in detail based on the following figures, wherein:

FIG. 1 illustrates the mobile electronic bidirectional counting apparatus main menu screen that displays the home button 100, boarding switch 402, debarking switch 404 and adjust switch 408.

FIG. 2 illustrates the mobile electronic bidirectional counting apparatus functioning in the boarding phase of operation.

FIG. 3 illustrates the mobile electronic bidirectional counting apparatus functioning in the debarking phase of operation.

FIG. 4 is a flowchart illustrating process performed by the mobile electronic bidirectional counting apparatus when performed from both boarding and debarking operations.

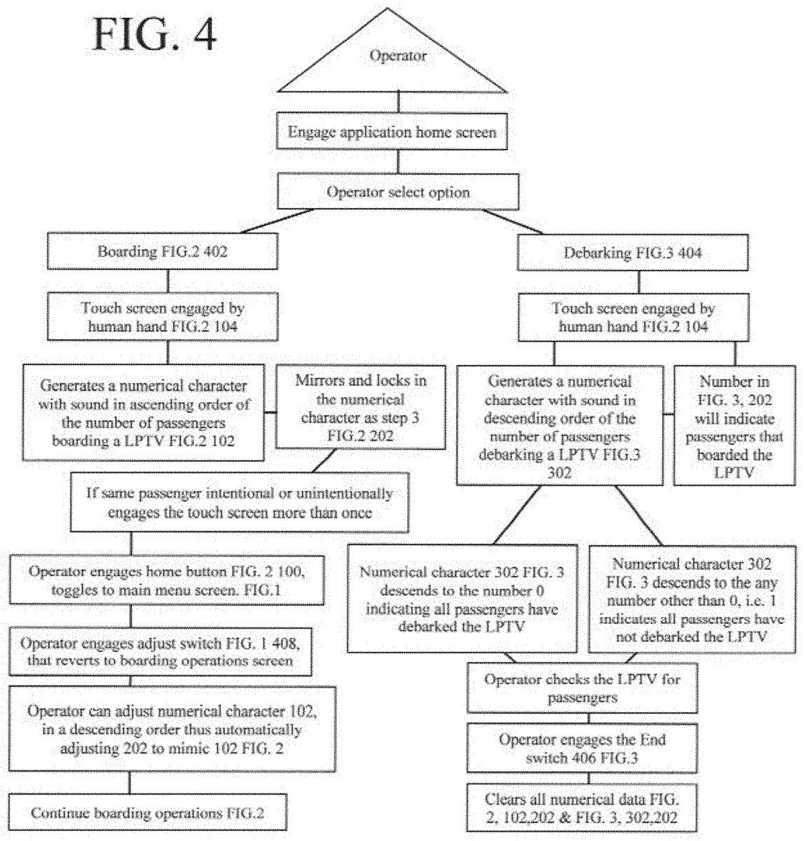

### DETAILED DESCRIPTION

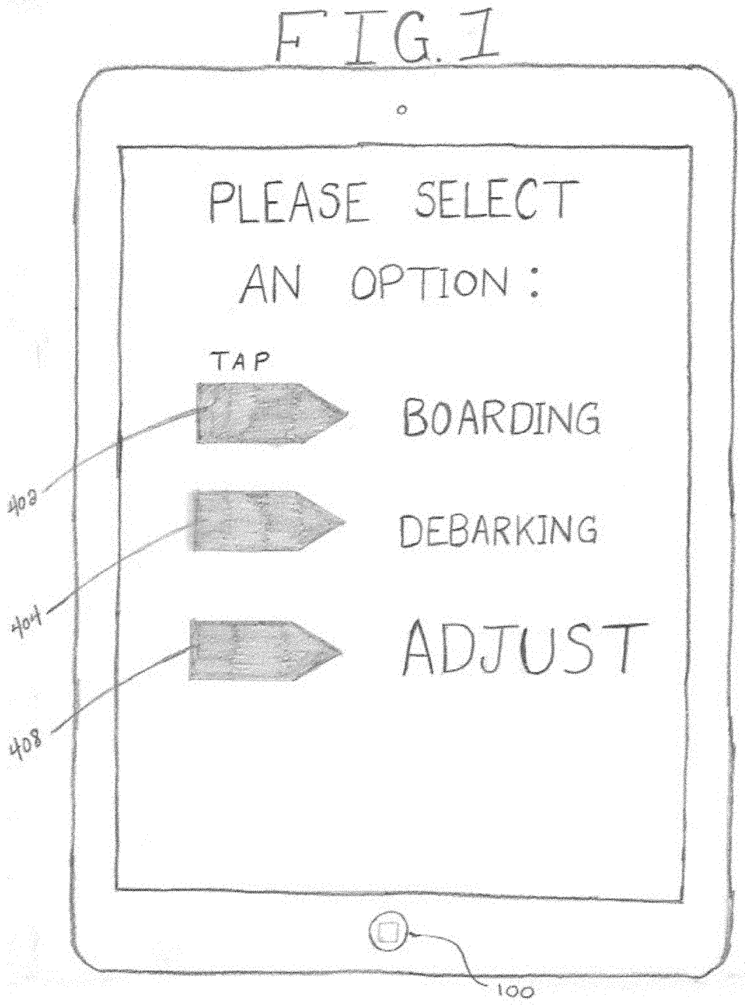

FIG. 1 illustrates the mobile electronic bidirectional counting apparatus main menu screen that displays the home button 100, boarding switch 402, debarking switch 404 and the adjust switch 408.

The advantages of the invention, described herein, is a mobile electronic bidirectional counting apparatus for capturing and conveying by numerical display with sound the number of passengers that board and debark any large passenger transportation vehicle (LPTV). The application is further designed to operate on any operating system (OS) with touch screen capabilities.

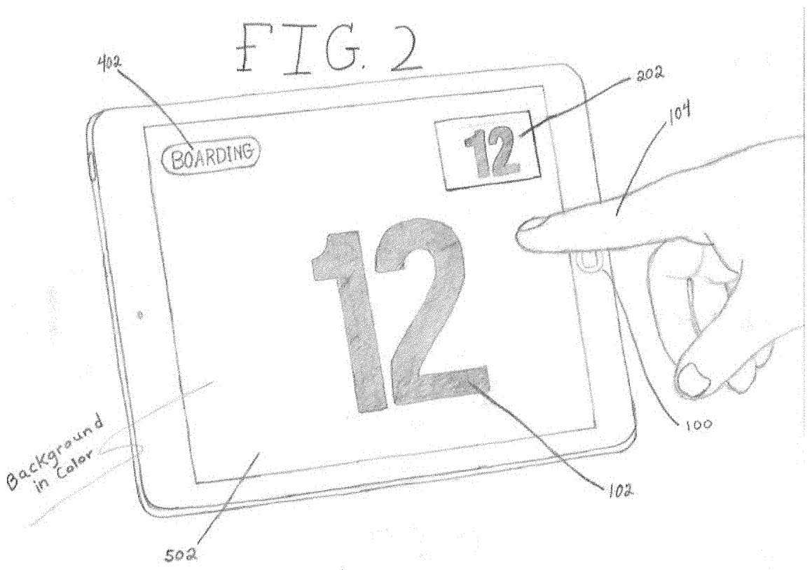

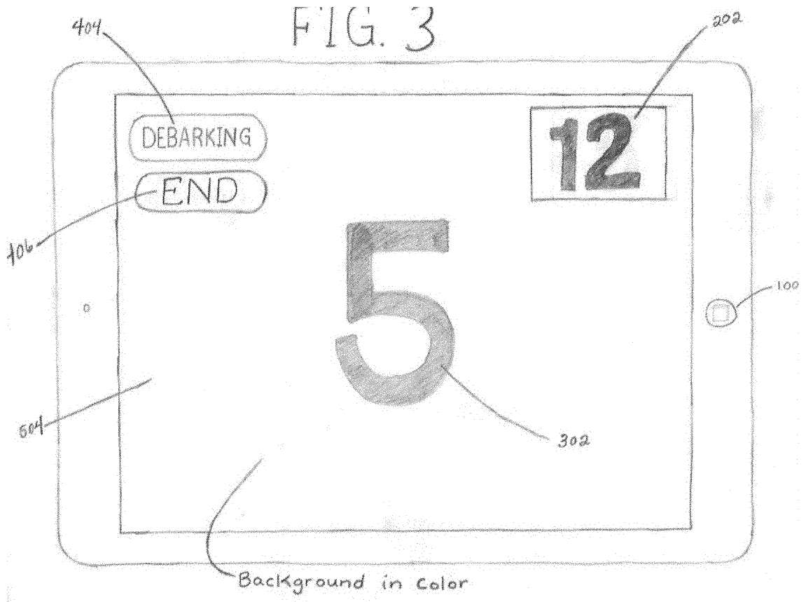

FIG. 2 illustrates the mobile electronic bidirectional counting apparatus functioning in the boarding phase of operation with a boarding switch 402. FIG. 2 further, illustrates when the touch screen is physically engaged by a human hand 104 a numeric character is displayed in ascending order that indicates the total number of passengers that boards a LPTV 102. FIG. 2 also illustrates a smaller screen positioned in the upper right corner of the touch screen that records and locks in the number of passengers that entered the LPTV 202. During the boarding phase of operation both displayed numbers 102 & 202 should be identical. The home button 100 allows the operator to toggle to the main menu screen FIG. 1 to gain access to different operational functions (i.e. boarding, debarking, and adjust). Once the debarking switch (404 FIG. 3) is activated the numerical display FIGS. 2&3, 202 becomes a locked display and will not change until the end of said bus route. Within the boarding phase of operation, the screen displays a backdrop 502.

FIG. 3 illustrates the mobile electronic bidirectional counting apparatus functioning in the debarking phase of operation with a debarking switch 404. FIG. 3 further, illustrates when the touch screen is physically engaged by a human hand FIG. 2, 104 a numeric character is displayed in descending order FIG. 3, 302 indicating the number of passengers that debarks the LPTV. FIG. 3 also illustrates a smaller screen positioned in the upper right corner of the touch screen, that displays the number of passengers that entered the LPTV FIG. 2, 202 during the boarding phase of operation. The number displayed in FIGS. 2, 102 & 202 in the boarding operation screen will be displayed when the debarking phase of operation is activated. Once a debarking passenger physically engages the touch screen-sensing pad, the debarking phase of operation begins generating numerical characters with sound in a descending order FIG. 3, 302. The numerical character displayed in FIG. 3, 202 will remain the same displaying the number of passengers that boarded the LPTV in the boarding phase of operation FIG. 2, 202.

Within the debarking phase of operation, the screen may display a backdrop 504. Additionally, the end switch FIG. 3, 406 once engaged will clear all displayed numbers in FIG. 3, 202 & 302 therefore, this switch should only be activated at the end of LPTV operations. The end button in addition to clearing all the displayed data, will verbalize “check for children.”

FIG. 1 illustrates the mobile electronic bidirectional counting apparatus adjust switch 408. The adjust switch allows the operator to adjust the numerical character if a passenger intentionally or unintentionally touches the keypad more than once while boarding the LPTV.

While implementations have been described in specific attributes, it is recognized that persons skilled in this art will readily perceive other variation and or modifications to the above descriptions. Therefore, all variations or modifications will be embraced.

The claim as the invention is:

1. A mobile electronic bidirectional counting apparatus comprising of two application units, two function units and a memory storing instruction. The first application unit runs the applications program within the execution phase of operation; in conjunction, the first function units generates a specific tasks output upon the completion of the first function execution unit; which displays a numerical character and sound corresponding to the displayed character. The memory-storing unit stores the number of passengers that enter the LPTV. The second application unit operates in a different application program. The second function execution unit operates in and environment different from the first execution unit. Upon completion of the first function execution unit, the second function unit is activated by the second application unit.

2. The mobile electronic bidirectional counting apparatus of claim 1, wherein the first application unit within the boarding phase; the first function unit execution delivers information to be used in creating ascending numeric calculations with sound equal to the numeric character displayed on the touch screen sensing pad. The memory-storing unit records and stores the first function unit information and displays the numerical Character in the upper right hand portion of the touch screen-sensing pad.

3. The mobile electronic bidirectional counting apparatus of claim 1, wherein the second application unit within the debarking phase; the second function unit execution delivers information to be used in creating descending numeric calculations with sound equal to the numeric character displayed on the touch screen sensing pad.

4. The mobile electronic bidirectional counting apparatus of claim 1, wherein the memory storing unit functions within the first application unit; wherein the first function execution unit transmits a numerical calculation and displays it on a smaller screen in the upper right portion of the larger screen equal to the numerical calculation that coincides with the display on the larger touch screen sensing pad.

5. The mobile electronic bidirectional counting apparatus of claim 1, wherein the first application unit has functions of displaying a main menu setting screen for a specific setting detail (i.e. boarding, debarking and adjust) on a display and receiving an operation to be performed on the setting screen; wherein, the second function execution unit activated by the operator upon completion of the first function execution, wherein the desired phase is selected from the screen that displays the settings and receives that operational arrangement.

6. A mobile electronic bidirectional counting apparatus of claim 5, The first initial operation based on the operator; displays an initial setting screen designed to perform in the boarding phase of operation; wherein the screen displays a backdrop screen in the boarding phase of operations; the second setting initiated by the operator is the debarking phase of operation in which the operator sets the setting to the debarking position to perform debarking operations. Additionally, the backdrop screen will display during the phases of operation. The operational buttons are easily distinguished from one another.

7. The mobile electronic bidirectional counting apparatus according to claim 6, wherein the application is further configured to process the instructions to: detect a passenger boarding and debarking a LPTV using screen touch recognition.

8. The mobile electronic bidirectional counting apparatus according to claim 7, wherein the application is further configured to process the instructions to: detect a passenger boarding the LPTV by the passenger touching the screen of an electronic device; thus, generating ascending numerical information; indicating a passenger boarding the vehicle based on the displayed numerical notation that is displayed on the mobile electronic device screen, coupled with sound that specifically coincides with the displayed numerical notation.

9. The mobile electronic bidirectional counting apparatus according to claim 7, wherein the application is further configured to process the instructions to: detect a passenger debarking the LPTV by the passenger touching the screen of an electronic device; thus, generating descending numerical information indicating a passenger debarking the LPTV based on the displayed numerical notation that is displayed on a the mobile electronic device screen coupled with sound that specifically coincides with the displayed numerical notation.

10. Additionally, the mobile electronic bidirectional counting apparatus is further designed to display two screens on the touch screen sensing pad; the smaller display will be positioned in the upper right portion of the touch screen sensing pad; this display will not be bidirectional, but will show the same numerical notation equal to the numerical notation on the larger screen display which indicates the number of passengers entering the LPTV. The larger screen numerical display will be significantly larger than the memory storing unit screen, and will be positioned in the center most portion of the mobile electronic device touch screen sensing pad.

11. The significant difference between the two screens is that the smaller screen operates in a memory storing capacity, thus, storing and displaying the total number of passengers that enter the LPTV. The memory-storing unit operates during the boarding phase of operation, and will display the exact numerical notation as seen on the larger screen. The larger screen will operate as a bidirectional display that will display a numerical notation equal to the number of passengers that board and debark the LPTV depending on the phase of operation.

12. The mobile electronic bidirectional counting apparatus of claim 10, wherein the memory-storing unit only operates in the boarding phase of operation; the memory-storing unit will display on both the boarding and debarking screens the numeric notation generated during the boarding phase of operation.

13. A mobile electronic bidirectional counting apparatus comprising of: wherein the first application runs and operates in an execution setting, where the application program runs; the first execution function operates in the execution environment, thus providing a specific function after the first function of execution causes the first application to become active; Further, the activation of the second application process, operates in a separate execution environment different from the first execution environment, and within a different running application program separate from the first application program. Additionally, the second function execution operates in the different execution environment, meaning that the activation of the first function execution will respond and become active after the second function execution is prompted by the second application, which inter acquires a processed result executed by the first function execution which transmits the result to the second running application thereof.
